(19) United States
(12) Patent Application Publication
(10) Pub. No.: US 2021/0045513 A1
(43) Pub. Date: Feb. 18, 2021

(54) RECHARGEABLE NAIL POLISHING APPARATUS

(71) Applicant: RIGHTNOW CO., LTD, New Taipei City (TW)

(72) Inventor: KUO-CHANG CHENG, New Taipei City (TW)

(21) Appl. No.: 16/538,813

(22) Filed: Aug. 12, 2019

(51) Int. Cl. A45D 29/14; H02J 7/00

(52) U.S. Cl. CPC A45D 29/14; H02J 7/0045; H02J 2007/005; H02J 2007/0049; H02J 7/0047

(57) ABSTRACT

Provided is a rechargeable nail polishing apparatus, including a charging stand and a grinder. The charging stand includes a pedestal, a power supply portion and a support portion; the power supply portion includes a positive charging terminal, a negative charging terminal, a first power input port, and a first control unit. The grinder includes a casing, a grinding assembly mechanism, a driving member, at least one rechargeable battery, a positive terminal contact elastic piece, a negative terminal contact elastic piece and a second control unit. The grinder is inclined against the power supply portion and the support portion, the positive terminal contact elastic piece contacts the positive charging terminal, and the negative terminal contact elastic piece contacts the negative charging terminal, so that the first power input port, the first control unit, the second control unit and the at least one rechargeable battery form a loop.

### BACKGROUND OF THE INVENTION

### 1. Field of the Invention

The present invention relates generally to a nail polishing apparatus, and more particularly, to a rechargeable nail polishing device that is used to grind cured gel on fingernails or toenails.

### 2. The Prior Arts

Manicure is a procedure for decorating to beautify fingernails or toenails. When working in nail art, a gel is usually applied to the fingernail or toenail, and then the gel is irradiated and cured by ultraviolet light generated by an ultraviolet curing device on the nails. After the gel is cured, the manicurist uses a wired nail polishing apparatus to grind the cured gel on the nails for polishing. In addition, during the removal process, the manicurist will also use a wired nail polishing apparatus to remove the cured gel on the nails in order to recreate the new nail art.

A wired nail polishing apparatus extends through a power cord to plug into a remote power outlet location to obtain a source of electrical power.

However, when a manicurist uses a wired nail polishing apparatus for nail work, the apparatus will be constantly interfered by the presence of the power cord and reduce the efficiency of nail art work.

Furthermore, people who shuttle on the path of the power cord of the wire d nail polishing apparatus may be tripped by the power cord, which is dangerous and may suddenly unplug the power cord from the power outlet to say the least.

Besides, the power cord of the wired nail polishing apparatus has no other use than power connection.

### SUMMARY OF THE INVENTION

A primary objective of the present invention is to provide a rechargeable nail polishing apparatus that uses a charging stand to directly charge a rechargeable battery in a nail polishing apparatus, so that the nail polishing apparatus can operate wirelessly, and the user does not be interfered with a power cord when operating the nail polishing apparatus, which is easy to operate, free of the problem of tripping over the power cord, increasing the efficiency of the nail work and reducing the space for desktop use.

Another objective of the present invention is to provide a rechargeable nail polishing apparatus, having a charging stand with the functions of charging the nail polishing apparatus and placing the nail polishing apparatus obliquely thereon, as well as supplying power to other electronic device and placing other grinding member obliquely thereon.

In order to achieve the foregoing objectives, the present invention provides a rechargeable nail polishing apparatus comprising a charging stand and a grinder; wherein:

The charging stand comprises a pedestal, a power supply portion and a support portion; the power supply portion being disposed on the pedestal and comprising a positive charging terminal, a negative charging terminal, a first power input port, and a first control unit; the first power input port being electrically connected to an external power source, and the first control unit being electrically connected to the positive charging terminal, the negative charging terminal and the first power input port; the supporting portion being disposed on the pedestal and at a distance from the power supply portion; the height of the support portion being greater than the height of the power supply portion.

The grinder comprises a casing, a grinding assembly mechanism, a driving member, at least one rechargeable battery, a positive terminal contact elastic piece, a negative terminal contact elastic piece and a second control unit; the grinding assembly mechanism being disposed on top of the casing to provide a grinding member disposed thereon, the driving member being disposed inside the casing and configured to drive the grinding member to rotate, the at least one rechargeable battery being disposed inside the casing, and the second control unit being disposed in the casing and electrically connecting the driving member, the at least one rechargeable battery, the positive terminal contact elastic piece and the negative terminal contact elastic piece.

The grinder is inclined against the power supply portion and the support portion, the positive terminal contact elastic piece contacting the positive charging terminal, and the negative terminal contact elastic piece contacting the negative charging terminal, so that the first power input port, the first control unit, the second control unit and the at least one rechargeable battery form a loop.

Preferably, the top of the power supply portion comprises a recess, the recess comprises a front side slope and a rear side slope, and the positive charging terminal and the negative charging terminal are both disposed on the front side slope; wherein the grinder comprises a base; the base is disposed at the bottom of the casing, and the positive terminal contact elastic piece and the negative terminal contact elastic piece are disposed at bottom of the base; and wherein the casing abuts against the rear side slope, and the bottom of the base abuts against the front side slope.

Preferably, the front side slope comprises a first latching portion, the bottom of the base comprises a second latching portion, and the first latching portion is embedded in the second latching portion.

Preferably, one of the first latching portion and the second latching portion is a recessed groove, and the other is a bump.

Preferably, the first latching portion and the second latching portion are both curved.

Preferably, the front side slope is recessed with a positioning groove, and shape and size of the positioning groove respectively correspond to shape and size of the base; the positive charging terminal, the negative charging terminal and the first clamping portion are both disposed inside the positioning groove.

Preferably, the support portion is recessed with a chute, the chute and the rear side slope are inclined in the same direction and have the same inclination extent, and the casing abuts against the chute.

Preferably, the rear side slope comprises an upper slope, with groove wall having shape and size corresponding to shape and size of a lower end of the casing; and wherein the shape and size of the chute correspond to shape and side of an upper end of the casing.

Preferably, an outer side of the base is disposed with a switch speed knob, and the switch speed knob is electrically connected to the second control unit; and wherein the rear side slope comprises a lower slope, and the lower slope is located between the upper slope and the front side slope, the lower slope is recessed inwardly with respect to the upper slope and forms a step difference with the upper slope, and the difference is greater than or equal to the distance of the switch speed knob protruding from the outer side of the base.

Preferably, the grinder comprises a second power input port, and the second power input port is disposed at the bottom of the base, electrically connected to the second control unit, and electrically connected to an external power source.

Preferably, a plurality of grinding member slots are respectively defined on two sides of the support portion, and each of the grinding member slots is configured to insert a grinding member therein.

Preferably, each of the grinding member slots extends inwardly and downward, and has a slanted trough shape.

Preferably, the power supply portion comprises at least one power output port, the at least one power output port is electrically connected to an electronic device, and the first control unit is electrically connected to the at least one power output port.

Preferably, a plurality of power indicator windows are disposed on outer side of the casing, and a plurality of power indicator lights are disposed on inner side of the casing, and positions of the power indicator lights correspond to positions of the power indicator windows, and the plurality of power indicator lights are electrically connected to the second control unit.

The advantage of the present invention is that the charging battery is directly charged by the charging stand, so the grinder can be operated wirelessly, and the user is not interfered by the power cord when operating the grinder. The operation is easy, and there will be no problems of tripping over the power cord, increasing the efficiency of nail art work, work safety and reducing the use of desktop space.

Further, in addition to charging the grinder and providing the grinder to be placed obliquely thereon, the charging stand has the purpose of simultaneously supplying power to the electronic device other than the grinder and providing the grinding member obliquely placed thereon.

Moreover, when the grinder is inclined against the power supply portion and the support portion, the combination of the first latching portion and the second latching portion can provide a good anti-slip effect and a foolproof effect to the base of the grinder.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of the rechargeable nail polishing apparatus of the present invention;

FIG. 2 is an exploded view of the rechargeable nail polishing apparatus of the present invention;

FIG. 3 is a cross-sectional view of the rechargeable nail polishing apparatus of the present invention;

FIG. 4 is a perspective view of the charging stand of the present invention;

FIG. 5 is a front view of the charging stand of the present invention;

FIG. 6 is a top view of the charging stand of the present invention;

FIG. 7 is an exploded view of the grinder of the present invention;

FIG. 8 is a front view of the grinder of the present invention;

FIG. 9 is a top view of the grinder of the present invention;

FIG. 10 is a bottom view of the grinder of the present invention;

FIG. 11 is a schematic view of the charging stand performing charging to the grinder of the present invention;

FIG. 12 is a schematic view of the charging stand providing power to a USB desk lamp of the present invention; and

FIG. 13 is a schematic view of the grinder of the present invention directly charged through a power cord.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

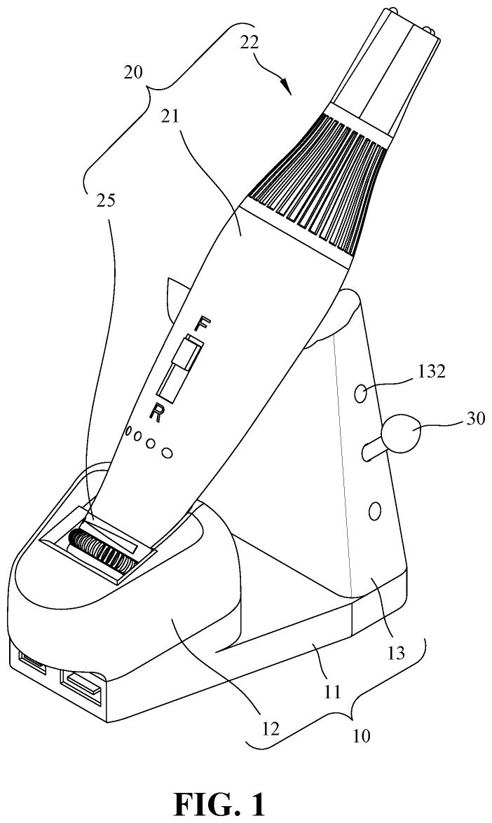

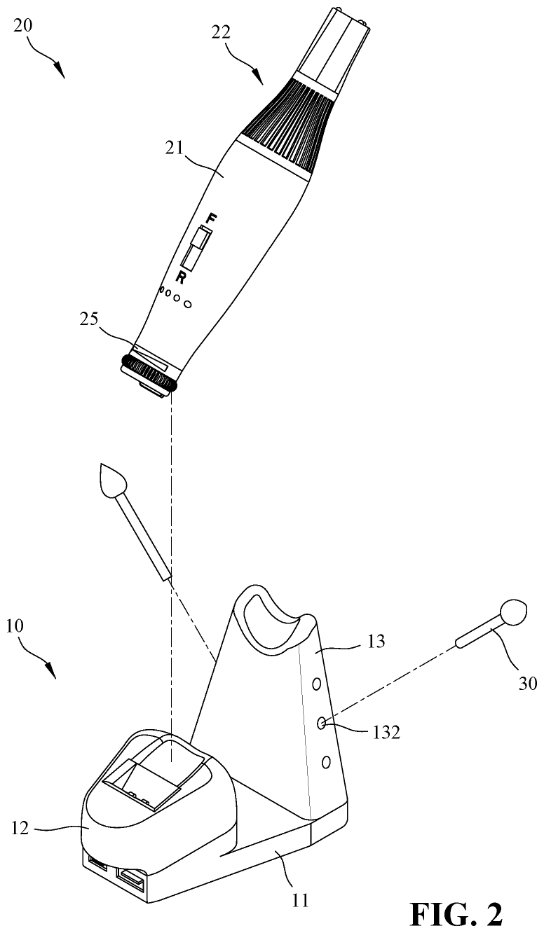

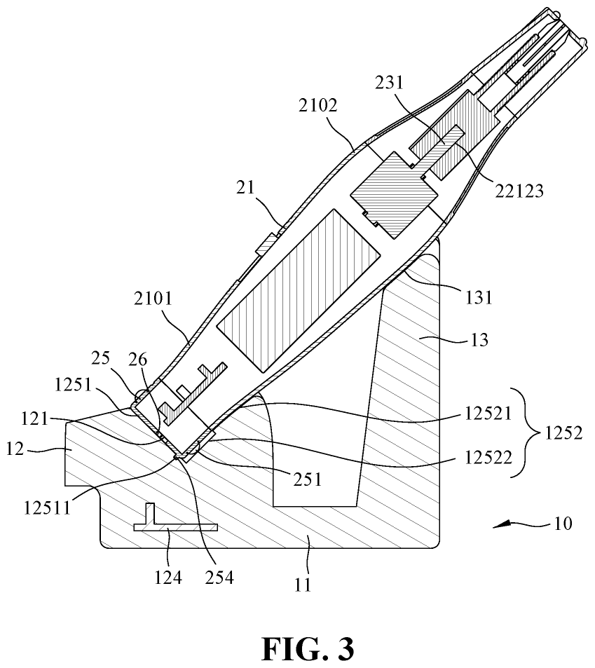

Referring to FIG. 1 to FIG. 3, FIG. 1 is a schematic view of the rechargeable nail polishing apparatus of the present invention; FIG. 2 is an exploded view of the rechargeable nail polishing apparatus of the present invention; FIG. 3 is a cross-sectional view of the rechargeable nail polishing apparatus of the present invention. The rechargeable nail polishing apparatus of the present invention comprises a charging stand 10 and a grinder 20.

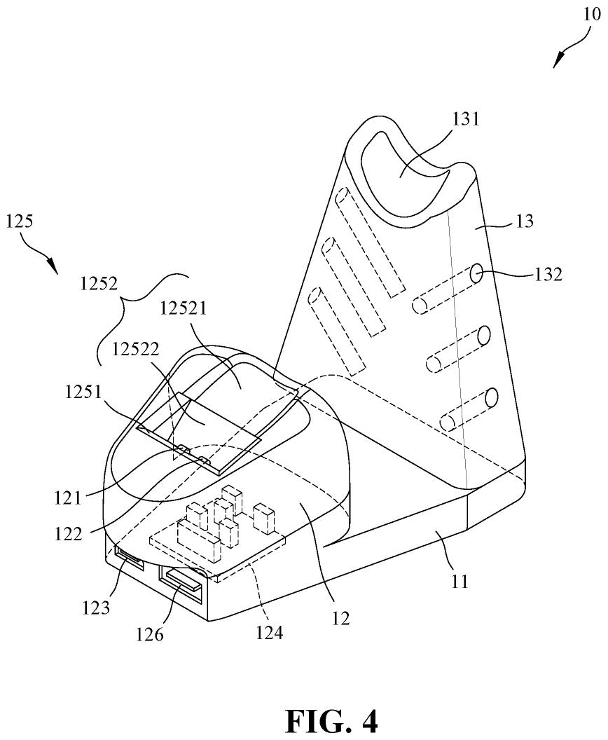

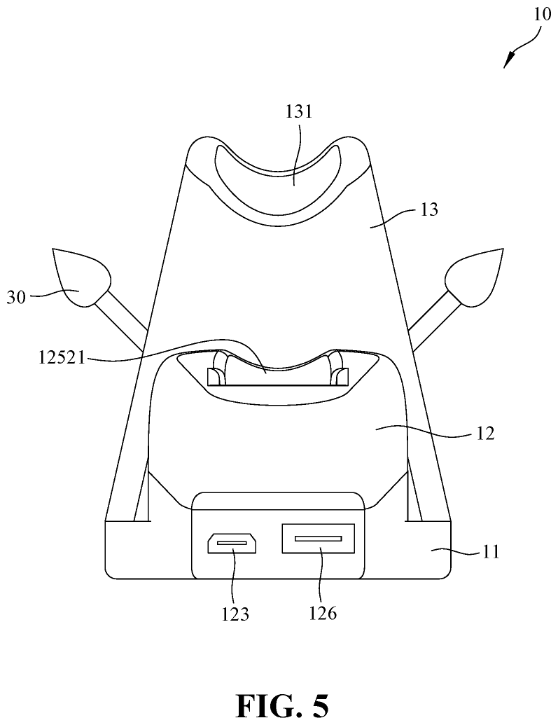

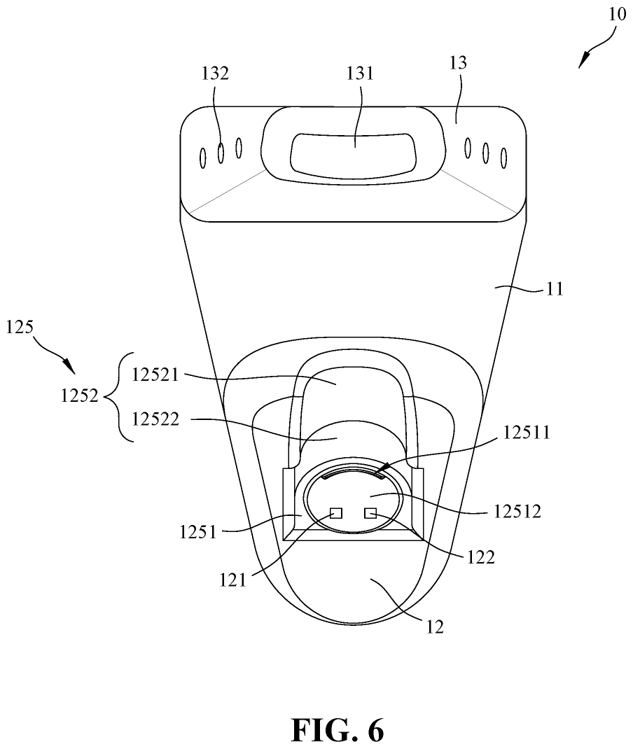

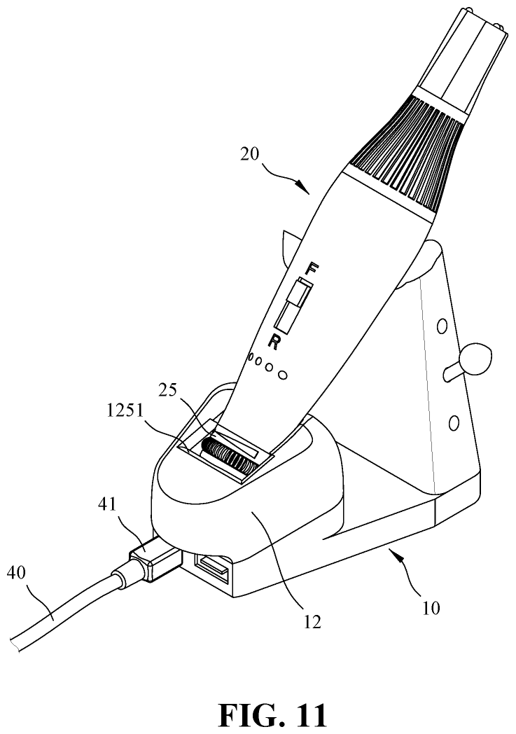

Referring to FIG. 4 to FIG. 6, FIG. 4 is a perspective view of the charging stand of the present invention; FIG. 5 is a front view of the charging stand of the present invention; FIG. 6 is a top view of the charging stand of the present invention. The charging stand 10 comprises a pedestal 11, a power supply portion 12 and a support portion 13. The power supply portion 12 is disposed on the pedestal 11 and comprises a positive charging terminal 121, a negative charging terminal 122, a first power input port 123, and a first control unit 124. The first power input port 123 is electrically connected to an external power source (see FIG. 11), and the first control unit 124 is electrically connected to the positive charging terminal 121, the negative charging terminal 122 and the first power input port 123. The supporting portion 13 is disposed on the pedestal 11 and at a distance from the power supply portion 12. The height of the support portion 13 is greater than the height of the power supply portion 12. More specifically, the power supply portion 12 is disposed on the front side of the pedestal 11 and protrudes upward, and the support portion 13 is disposed on the rear side of the pedestal 11 and also protrudes upward. The protrusion height of the support portion 13 with respect to the pedestal 11 is larger than the protrusion height of the power supply portion 12 with respect to the pedestal 11.

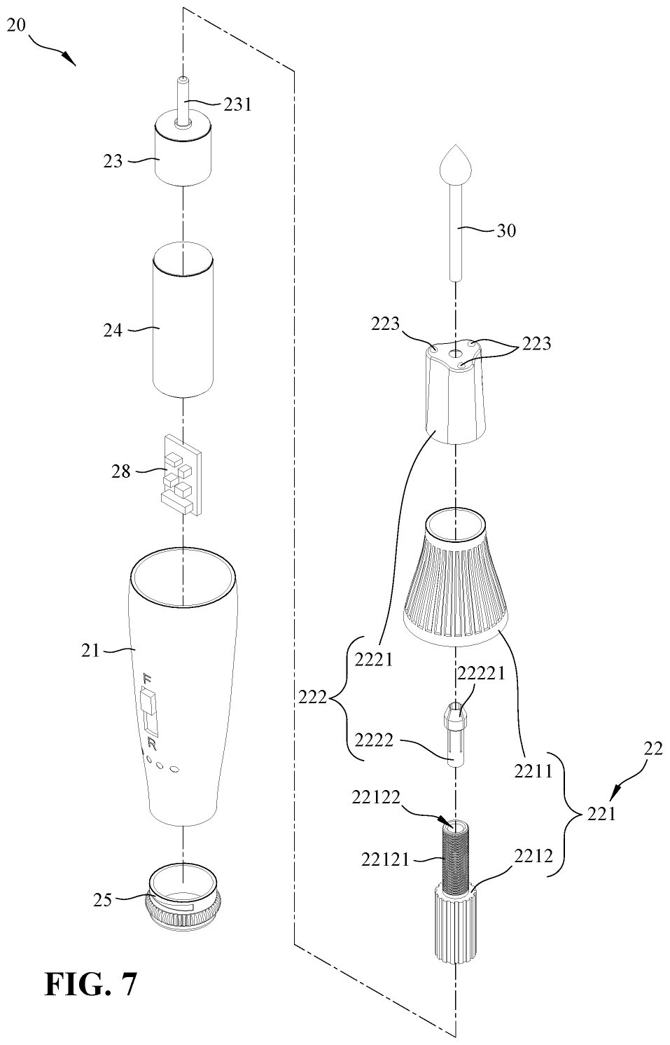

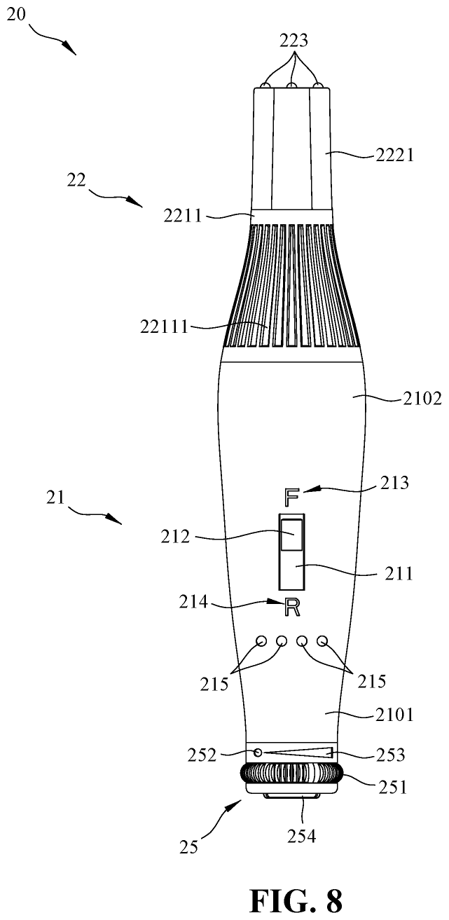

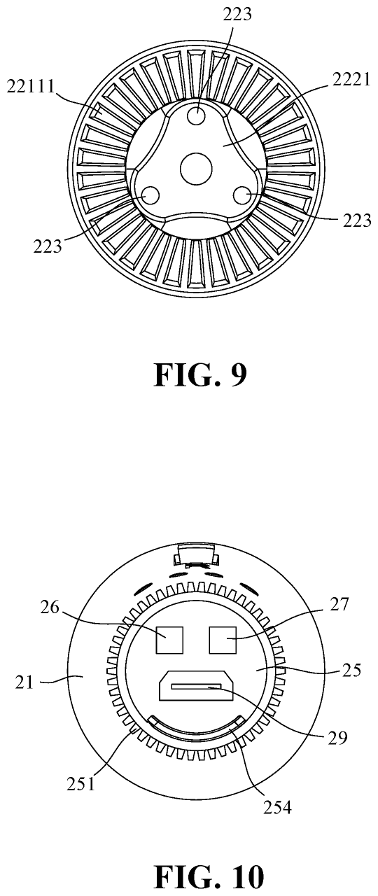

Referring to FIG. 7 to FIG. 10, FIG. 7 is an exploded view of the grinder of the present invention; FIG. 8 is a front view of the grinder of the present invention; FIG. 9 is a top view of the grinder of the present invention; FIG. 10 is a bottom view of the grinder of the present invention. The grinder 20 comprises a casing 21, a grinding assembly mechanism 22, a driving member 23, at least one rechargeable battery 24, a base 25, a positive terminal contact elastic piece 26, a negative terminal contact elastic piece 27 and a second control unit 28. The grinding assembly mechanism 22 is disposed on top of the casing 21 to provide a grinding member 30 disposed thereon. The driving member 23 is disposed inside the casing 21 and configured to drive the grinding member 30 to rotate. The at least one rechargeable battery 24 is disposed inside the casing 21. The base 25 is disposed at the bottom of the casing 21. The second control unit 28 is disposed in the casing 21 and electrically connecting the driving member 23, the at least one rechargeable battery 24, the positive terminal contact elastic piece 26 and the negative terminal contact elastic piece 27.

The driving member 23 is a motor, and a long slot 211 is defined in the outer side of the casing 21; a steering switch button 212 is slidably disposed in the long slot 211, and is electrically connected to the second control unit 28 for switching the driving member 23 to rotate forwardly or reversely. The outer side of the casing 21 has a forward rotation indicating portion 213 above the long groove 211, and the outer side of the casing 21 has a reverse rotation indicating portion 214 below the long groove 211. In a preferred embodiment of the present invention, the forward rotation indicating portion 213 is an English letter “F”, and the reverse rotation indicating portion 214 is an English letter “R”. A plurality of power indicator windows 215 is disposed on the outer side of the casing 21 below the reverse rotation indicating portion 214. The inner side of the casing 21 is provided with a plurality of power indicator lights (not shown), and the positions of the power indicator lights are respectively corresponding to the position of the power indicator window 215. The power indicator lights are electrically connected to the second control unit 28.

As shown in FIG. 3 and FIG. 7, the grinding assembly mechanism 22 comprises a quick disassembly module 221, a fixed module 222, and at least one illumination unit 223. The quick disassembly module 221 comprises a locking member 2211 and a quick release member 2212. The locking member 2211 is disposed at the top end of the casing 21 and has a conical shape, and the outer side is provided with a plurality of longitudinal grooves 22111. The quick release member 2212 is disposed inside the locking member 2211, with a rod 22121 protruding from the top, and a receiving hole 22122 defined concavely at the bottom. The rod 22121 is disposed with a shaft hole 22123. The fixed module 222 comprises a socket 2221 and a chuck 2222. The socket 2221 is disposed at a top end of the locking member 2211, and a through hole 22211 is defined in the top. The chuck 2222 is inserted into the shaft hole 22123 of the rod 22121 and has a clamping portion 22221. The at least one illumination unit 223 is disposed on the top of the socket 2221 and electrically connected to the second control unit 28. The driving member 23 has a driving shaft 231 which is inserted into the receiving hole 22122 of the quick release member 2212. In a preferred embodiment of the present invention, the socket 2221 has a triangular prism shape, and all three corners are rounded; the grinding assembly mechanism 22 comprises three illumination units 223, and the three illumination units 223 are respectively disposed on the top of the three corners of the socket 2221.

From the perspective of the assembly, the rechargeable battery 24 may be a non-removable internal battery or a detachable battery. From the perspective of the rechargeable chemical material, the rechargeable battery 24 may be a nickel-hydrogen battery, a lithium battery, or a battery made of other rechargeable chemical materials. In addition, the number of rechargeable batteries 24 may depend on the internal volume of the casing 21, and the number is at least one.

A switch speed knob 251 is disposed on the outer side of the base 25, and the switch speed knob 251 is electrically connected to the second control unit 28. The outer side of the base 25 has a switch indicator window 252 above the switch speed knob 251. The inner side of the base 25 is disposed with a switch indicator light (not shown). The position of the switch indicator light corresponds to the position of the switch indicator window 252, and the switch indicator light is electrically connected to the second control unit 28. The outer side of the base 25 is disposed with a rotational speed indicator portion 253 on the side of the switch indicator window 252. The rotational speed indicator portion 253 is for displaying the rotational speed of the drive shaft 231.

The operation mode of the rechargeable nail polishing apparatus of the present invention will be described below with reference to the drawings.

First, the grinder 20 is taken out from the charging stand 10. The grinding member 30 is taken out, passes through the through hole 22211 of the socket 2221 and is fixed in the clamping portion 22221 of the chuck 2222. The locking member 2211 is rotated such that the quick release member 2212 can secure the grinding member 30 to the chuck 2222. The switch speed knob 251 is rotated such that the second control unit 28 turns on the drive shaft 231 of the driving member 23, turns on the switch indicator light, and turns on the illumination units 223. The user can see through the switch indicator window 252 that the switch indicator light is illuminated, and that the driving member 23 is turned on. The drive shaft 231 of the driving member 23 further drives the quick release member 2212 and the chuck 2222 to rotate synchronously, whereby the grinding member 30 begins to rotate. The user can adjust the rotational speed of the drive shaft 231 by rotating the switch speed knob 251, and the rotational speed indicator portion 253 can show the rotational speed of the drive shaft 231. At this point, the user can hold the grinder 20, align the grinding member 30 with the fingernail or toenail to modify or remove the cured gel on the fingernail or toenail. During the grinding process, the illumination units 223 are capable of providing sufficient light to allow the user to clearly see the cured gel on the fingernails or toenails.

During the operation, if the user wants the grinding member 30 to rotate forward, the steering switching button 212 must be moved up to the top end of the long slot 211 in accordance with the instruction of the forward rotation indicating portion 213, and the second control unit 28 controls the drive shaft 231 to rotate forward, and the drive shaft 231 further drives the quick release member 2212 and the chuck 2222 to rotate forward synchronously, so that the grinding member 30 rotates forward synchronously. If the user wants the grinding member 30 to rotate reversely, the steering switching button 212 must be moved down to the bottom end of the long slot 211 as instructed by the reverse rotation indicating portion 214, and the second control unit 28 controls the drive shaft 231 to rotate reversely. The drive shaft 231 further drives the quick release member 2212 and the chuck 2222 to rotate reversely in synchronization so that the grinding member 30 rotates reversely synchronously.

The user can see that the power indicator lights are turned on or off through the power indicator window 215. When the power of the rechargeable battery 24 is sufficient, all of the four power indicator lights are illuminated; as the grinder 20 is used, the amount of the power of the rechargeable battery 24 will gradually decrease, and the power indicator lights are sequentially turned off one by one.

After the power of the rechargeable battery 24 is completely exhausted, the drive shaft 231 stops rotating, and the quick release member 2212 and the chuck 2222 stop rotating synchronously, so that the grinding member 30 stops rotating synchronously, the switch indicator lights and the illumination unit 223 are all extinguished. Alternatively, the user can rotate the switch speed knob 251 so that the second control unit 28 controls the drive shaft 231 of the driving member 23 to stop rotating, and the switch indicator lights and the illumination units 223 are all extinguished.

As shown in FIG. 1 to FIG. 3, before or after the use of the grinder 20, the user can place the grinder 20 on the charging stand 10, and the grinder 20 abuts against the power supply portion 12 and the support portion 13 The first positive power input port 123, the first control unit 124, the second control unit 28, and the at least one rechargeable battery 24 form a loop.

Please refer to FIG. 11 for a schematic view of charging the grinder 20 by the charging stand 10 of the present invention. If at least one of the rechargeable batteries 24 is not fully charged, the user can insert a plug 41 at one end of a power cord 40 to the first power input port 123, and a plug (not shown) at the other end of the power cord 40 is inserted into a slot (not shown) and connected to an external power source (not shown). The external power source provides power to charge the at least one rechargeable battery 24 through the aforementioned loop. As the charging time increases, the amount of power of the rechargeable battery 24 will gradually increase. The power indicator lights are sequentially illuminated one by one, and the user can know the amount of power charged in the at least one rechargeable battery 24 through the number of the power indicator lights. Once the at least one rechargeable batteries 24 is fully charged, the power indicator lights are all turned on.

The external power source can be a commercial power or a mobile power source, the plug 41 of the power cord 40 is a micro USB 5V input plug, and the first power input port 123 is a micro USB 5V input slot, but is not limited to the above embodiment, any common power source can be used as the external power source. The plug 41 of the power cord 40 and the first power input port 123 can be other common input plugs and input ports, and other voltage level can also be used as the input voltage.

Moreover, as shown in FIG. 4, FIG. 5 and FIG. 6, the top of the power supply portion 12 has a recess 125. The recess 125 comprises a front side slope 1251 and a rear side slope 1252, and the positive charging terminal 121 and the negative charging terminals 122 are all disposed on the front side slope 1251. As shown in FIG. 3 and FIG. 10, the positive terminal contact elastic piece 26 and the negative terminal contact elastic piece 27 are both disposed at the bottom of the base 25. As shown in FIG. 1, FIG. 3, and FIG. 11, the casing 21 abuts against the rear side slope 1252, and the bottom of the base 25 abuts against the front side slope 1251.

As shown in FIG. 3 and FIG. 6, the front side slope 1251 has a first latching portion 12511; as shown in FIG. 2, FIG. 3, FIG. 8 and FIG. 10, the bottom portion of the base 25 has a second latching portion. 254. As shown in FIG. 3, the first latching portion 12511 is embedded in the second latching portion 254, to achieve the anti-slip, positioning and foolproof effect. For the anti-slip and positioning effect: the base 25 of the grinder 20 can be stably positioned on the front side slope 1251 without slipping and rotating, so as to ensure that the positive terminal contact elastic piece 26 stays in contact with the positive charging terminal 121, and the negative terminal contact elastic piece 27 stays in contact with the negative charging terminal 122. For the foolproof effect: the positive terminal contact elastic piece 26 is prevented from contacting the negative charging terminal 122, and the negative terminal contact elastic piece 27 is prevented from contacting the positive charging terminal 121.

In a preferred embodiment of the present invention, as shown in FIG. 3 and FIG. 6, the first latching portion 12511 is a recessed slot; as shown in FIG. 2, FIG. 3, FIG. 8 and FIG. 10, the second latching portion 254 is a bump. In other embodiments, the first latching portion 12511 can also be a bump, and the second latching portion 254 can also be a recessed slot. Preferably, the first latching portion 12511 and the second latching portion 254 are both curved. However, the first latching portion 12511 and the second latching portion 254 may be of other geometric shapes.

In a preferred embodiment of the present invention, as shown in FIG. 6, the front side slope 1251 is recessed with a positioning groove 12512. The shape and size of the positioning groove 12512 correspond to the shape and size of the base 25, and the positive charging terminal 121, the negative charging terminal 122 and the first latching portion 12511 are all disposed in the positioning groove 12512. Therefore, the base 25 of the grinder 20 can be positioned more stably on the front side slope 1251 without slipping.

In a preferred embodiment of the present invention, as shown in FIG. 1 to FIG. 6, the support portion 13 is recessed with a chute 131, and the chute 131 and the rear side slope 1252 are inclined in the same direction and have the same inclination extent, and the casing 21 abuts against the chute 131. Thereby, the grinder 20 can be inclined at a fixed angle against the power supply portion 12 and the support portion 13, and is less likely to slip.

Preferably, the rear side slope 1252 comprises an upper slope 12521, with groove wall having shape and size corresponding to shape and size of a lower end 2101 of the casing 21; and wherein the shape and size of the chute 131 correspond to shape and side of an upper end 2102 of the casing 21. Thereby, both the upper slope 12521 and the chute 131 can provide better positioning effect to the casing 21 of the grinder 20.

Preferably, as shown in FIG. 3, the rear side slope 1252 comprises a lower slope 12522, and the lower slope 12522 is located between the upper slope 12521 and the front side slope 1251, the lower slope 12522 is recessed inwardly with respect to the upper slope 12521 and forms a step difference with the upper slope 12521, and the difference is greater than or equal to the distance of the switch speed knob 251 protruding from the outer side of the base 25. Thereby a sufficient space above the lower slope 12522 is reserved to accommodate the switch speed knob 251.

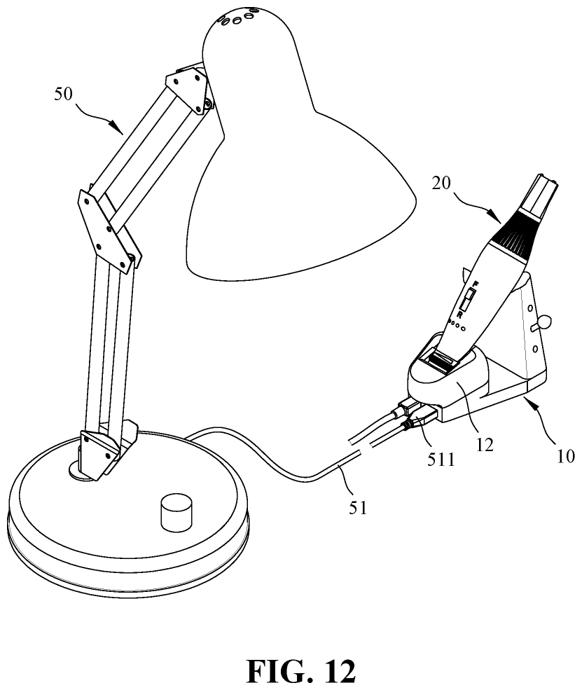

In a preferred embodiment of the present invention, as shown in FIG. 4, FIG. 5 and FIG. 12, the power supply portion 12 comprises at least one power output port 126, the at least one power output port 126 is electrically connected to an electronic device 50, and the first control unit 124 is electrically connected to the at least one power output port 126. Specifically, a plug 511 at one end of a power cord 51 of the electronic device 50 is inserted into the at least one power output port 126. Therefore, the power supply portion 12 can supply power to the electronic device 50 other than the grinder 20.

The at least one power output port 126 is a USB 5V output slot, and a plug 511 at one end of the power cord 51 is a USB 5V output plug, but is not limited thereto. The at least one power output port 126 and the plug 511 of the power cord 51 may be other common input ports and input plugs, and other voltage levels may be used for the input voltage.

The electronic device 50 may be a USB desk lamp (as shown in FIG. 12), a USB grinder, a USB hub, a USB air filter, a USB charging device for a mobile phone or a tablet, and so on. As such, while the grinder 20 is used, the electronic device 50 can be powered by the at least one power output port 126, which greatly increases the convenience and practicability of the present invention. In addition, the more the number of power output ports 126, the more the electronic device 50 can the charging stand 10 supply power to.

In a preferred embodiment of the present invention, as shown in FIG. 1 to FIG. 6, a plurality of grinding member slots 132 are respectively defined on two sides of the support portion 13, and each of the grinding member slots 132 is configured to insert a grinding member 30 therein. Preferably, as shown in FIG. 4, each of the grinding member slots 132 extends inwardly and downward, and has a slanted trough shape. The grinding member 30 is obliquely inserted into each of the grinding member slots 132. Herein, the grinding member 30 can be stably inserted into each of the grinding member slots 132 without falling out, and the user can easily take the grinding member 30 out of each of the grinding member slots 132.

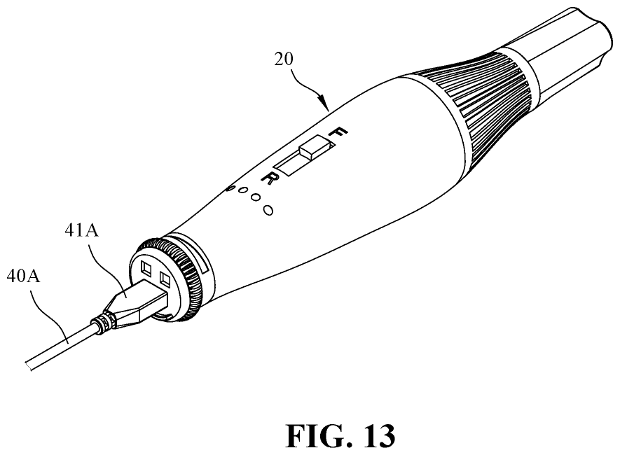

As shown in FIG. 10 and FIG. 13, the grinder 20 comprises a second power input port 29, and the second power input port 29 is disposed at the bottom of the base 25, electrically connected to the second control unit 28, and electrically connected to an external power source (not shown). In other words, the user can directly insert a plug 41A at one end of a power cord 40A into the second power input port 29, and a plug (not shown) at the other end of the power cord 40A is inserted into a slot (not shown) connected to an external power supply. The external power supply provides power to directly charge the at least one rechargeable battery 24 through the second control unit 28, and does not need to be charged through the charging stand 10.

The external power source can be a commercial power or a mobile power source, the plug 41A of the power cord 40A is a micro USB 5V input plug, and the second power input port 129 is a micro USB 5V input slot, but is not limited to the above embodiment, any common power source can be used as the external power source. The plug 41A of the power cord 40A and the second power input port 129 can be other common input plugs and input ports, and other voltage level can also be used as the input voltage.

In summary, in the present invention, the charging battery 24 is directly charged by the charging stand 10, so the grinder 20 can be operated wirelessly, and the user is not interfered by the power cord when operating the grinder 20. The operation is easy, and there will be no problems of tripping over the power cord, increasing the efficiency of nail art work, work safety and reducing the use of desktop space.

Further, in addition to charging the grinder 20 and providing the grinder 20 to be placed obliquely thereon, the charging stand 10 has the purpose of simultaneously supplying power to the electronic device 50 other than the grinder 20 and providing the grinding member 30 obliquely placed thereon.

Moreover, when the grinder 20 is inclined against the power supply portion 12 and the support portion 13, the combination of the first latching portion 12511 and the second latching portion 254 can provide a good anti-slip effect and a foolproof effect to the base 25 of the grinder 20.

Moreover, the combination of the first latching portion 12511 and the second latching portion 254 is further in collaboration with the technical features including the positioning groove 12512 of the front side slope 1251, the inclination extent of the rear side slope 1252 and the chute 131 of the support portion 13, the shape and size of the upper slope 12521 and the groove wall of the chute 131 corresponding to the shape and size of the lower end 2101 and the upper end 2102 of the casing 21 of the grinder 20 respectively, to provide better and more comprehensive anti-slip, positioning and foolproof effects to the casing 21 of the grinder 20.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A rechargeable nail polishing apparatus, comprising:
a charging stand and a grinder; the charging stand comprising a pedestal, a power supply portion and a support portion; the power supply portion being disposed on the pedestal and comprising a positive charging terminal, a negative charging terminal, a first power input port, and a first control unit; the first power input port being electrically connected to an external power source, and the first control unit being electrically connected to the positive charging terminal, the negative charging terminal and the first power input port; the supporting portion being disposed on the pedestal and at a distance from the power supply portion; the height of the support portion being greater than the height of the power supply portion; and
the grinder comprising a casing, a grinding assembly mechanism, a driving member, at least one rechargeable battery, a positive terminal contact elastic piece, a negative terminal contact elastic piece and a second control unit; the grinding assembly mechanism being disposed on top of the casing to provide a grinding member disposed thereon, the driving member being disposed inside the casing and configured to drive the grinding member to rotate, the at least one rechargeable battery being disposed inside the casing, and the second control unit being disposed in the casing and electrically connecting the driving member, the at least one rechargeable battery, the positive terminal contact elastic piece and the negative terminal contact elastic piece;
wherein the grinder is inclined against the power supply portion and the support portion, the positive terminal contact elastic piece contacts the positive charging terminal, and the negative terminal contact elastic piece contacts the negative charging terminal, so that the first power input port, the first control unit, the second control unit and the at least one rechargeable battery form a loop.

2. The rechargeable nail polishing apparatus according to claim 1, wherein the top of the power supply portion comprises a recess, the recess comprises a front side slope and a rear side slope, and the positive charging terminal and the negative charging terminal are both disposed on the front side slope; wherein the grinder comprises a base; the base is disposed at the bottom of the casing, and the positive terminal contact elastic piece and the negative terminal contact elastic piece are disposed at bottom of the base; and wherein the casing abuts against the rear side slope, and the bottom of the base abuts against the front side slope.

3. The rechargeable nail polishing apparatus according to claim 2, wherein the front side slope comprises a first latching portion, the bottom of the base comprises a second latching portion, and the first latching portion is embedded in the second latching portion.

4. The rechargeable nail polishing apparatus according to claim 3, wherein one of the first latching portion and the second latching portion is a recessed groove, and the other is a bump.

5. The rechargeable nail polishing apparatus according to claim 4, wherein the first latching portion and the second latching portion are both curved.

6. The rechargeable nail polishing apparatus according to claim 3, wherein the front side slope is recessed with a positioning groove, and shape and size of the positioning groove respectively correspond to shape and size of the base; the positive charging terminal, the negative charging terminal and the first clamping portion are both disposed inside the positioning groove.

7. The rechargeable nail polishing apparatus according to claim 2, wherein the support portion is recessed with a chute, the chute and the rear side slope are inclined in the same direction and have the same inclination extent, and the casing abuts against the chute.

8. The rechargeable nail polishing apparatus according to claim 7, wherein the rear side slope comprises an upper slope, with groove wall having shape and size corresponding to shape and size of a lower end of the casing; and wherein the shape and size of the chute correspond to shape and side of an upper end of the casing.

9. The rechargeable nail polishing apparatus according to claim 8, wherein an outer side of the base is disposed with a switch speed knob, and the switch speed knob is electrically connected to the second control unit; and wherein the rear side slope comprises a lower slope, and the lower slope is located between the upper slope and the front side slope, the lower slope is recessed inwardly with respect to the upper slope and forms a step difference with the upper slope, and the difference is greater than or equal to the distance of the switch speed knob protruding from the outer side of the base.

10. The rechargeable nail polishing apparatus according to claim 2, wherein the grinder comprises a second power input port, and the second power input port is disposed at the bottom of the base, electrically connected to the second control unit, and electrically connected to an external power source.

11. The rechargeable nail polishing apparatus according to claim 1, wherein a plurality of grinding member slots are respectively defined on two sides of the support portion, and each of the grinding member slots is configured to insert a grinding member therein.

12. The rechargeable nail polishing apparatus according to claim 11, wherein each of the grinding member slots extends inwardly and downward, and has a slanted trough shape.

13. The rechargeable nail polishing apparatus according to claim 1, wherein the power supply portion comprises at least one power output port, the at least one power output port is electrically connected to an electronic device, and the first control unit is electrically connected to the at least one power output port.

14. The rechargeable nail polishing apparatus according to claim 1, wherein a plurality of power indicator windows are disposed on an outer side of the casing, and a plurality of power indicator lights are disposed on an inner side of the casing, and positions of the power indicator lights correspond to positions of the power indicator windows, and the plurality of power indicator lights are electrically connected to the second control unit.
